(19) United States
(12) Patent Application Publication
(10) Pub. No.: US 2007/0029005 A1
(43) Pub. Date: Feb. 8, 2007

(54) Automatic liquid metering apparatus

(76) Inventors: Shih Yen Huang, Sanchong City (TW); Chiuan Yuan Chen, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 11/487,492

(22) Filed: Jul. 17, 2006

(30) Foreign Application Priority Data
Aug. 4, 2005 (TW) 094213311

(51) Int. Cl. B65B 1/04; B67D 5/08; B67D 5/56

(52) U.S. Cl. 141/288; 222/129.1; 222/105; 222/64; 141/352

(57) ABSTRACT

An automatic liquid metering apparatus is disposed with at least a liquid concentrate motor pump with a tube connected thereto and at least a diluting water motor pump with a tube connected thereto where the turning of the pumps is timed by a microprocessor to control the amounts of liquid concentrate and diluting water to be dispensed. The outlet tubing of the pump is connected to the outlet of liquid concentrate and diluting water via a check valve. A lift mechanism is provided at the concentrate/diluting water outlet, which allows the choice of small cup, medium cup or large pot by ascending or descending to the proper height. The stop point of the lift mechanism is microprocessor controlled to prevent the spurting of dispensed liquid concentrate and diluting water due to great distance between their outlet and the rim of cup to ensure sanitary and smooth dispensing of fluids. This invention features precision dispensing of concentrate and diluting water and low manufacturing costs.

### BACKGROUND OF INVENTION

1. Field of the Invention

The advent of biotechnology allows 5 grams of beverage concentrate to be made into 150 grams of drink. Thus a liquid metering apparatus needs to be designed with precision microprocessor to meet the consumer demands. The new metering apparatus design disclosed in this invention features a concentrate pump and a diluting water pump with respective outlet connected to the outlet of liquid concentrate and diluting water via a check value tubing. The pump outlet is disposed with at least a set of lift mechanism that ascends or descends in response to the rotation of pump motor which is under microprocessor control by the choice of small cup, medium cup or large pot. The vertical position of the small cup, medium cup and large pot as elevated or dropped by the lift mechanism is determined by the contact stop point as controlled by the rotation of pump motor, so liquid concentrate and diluting water dispensed into the cup or pot will not spurt out due to long distance between the outlet of liquid and the rim of cup. After the concentrate pump is stopped, a pressing mechanism will operate in order to squeeze out and then suck in remaining liquid concentrate from the outlet of tubing, such that the outlet of tubing will not contain any liquid drop. The apparatus disclosed herein ensures sanitary and smooth dispensing of fluids and features precision metering and low manufacturing costs.

2. Description of the Prior Art

For a long time, beverage drinks are either freshly squeezed or made from powder to keep their freshness and original flavor. However it is not exactly convenient for consumers to prepare drinks in such a manner.

Modern life stresses quality and speed. As the demands for liquid beverages rise, it is becoming more prevalent to dispense drinks by quickly diluting concentrate with water. The trend is also using modern technology to produce high quality liquid concentrate that retains the original flavor at lower costs. Such liquid concentrate is easy to dispense where small amount of concentrate can be made quickly into large amount of ready-to-drink beverage to satisfy the needs of consumers. In line with the age of concentrate beverage, the present invention features motor pump and check valve to meet the requirements for precision dispense of concentrate and address the drawbacks of prior art.

### SUMMARY OF INVENTION

The primary object of the present invention is to provide an automatic liquid metering apparatus which allows precision metered supply of liquid concentrate and diluting water through microprocessor programming to meet user's needs for quick, metered and sanitary dispensing of beverage.

To achieve the aforesaid objects, the automatic liquid metering apparatus of the present invention features a control process with a microprocessor to control the running time of motor pump, check valves and a lift mechanism, characterized in which the concentrate supply of the metering apparatus is connected to the inlet of motor pump via a tubing, the diameter of pump inlet is greater than that of pump outlet, and the pump outlet is connected to an internal tubing of lift mechanism via a check valve. When the motor stops running, the check valve is closed to stop the fluid from leaking or backflow due to siphonage. Also, with the inlet size of concentrate pump being greater than its outlet that more liquid comes in than discharge, it totally prevents the uneven flow of concentrated liquid in the pump caused by the presence of vacuum inside. The pump is akin to a syringe that draws in fluid rapidly and creates vacuum in the process before the syringe is completely filled. For the pumping of diluting water, regular pump or solenoid valve will work due to the better fluidity of diluting water. With the metered supply of liquid concentrate and diluting water, consumers can press the desired buttons to get the properly diluted drink.

Another feature of the present invention provides a new design, characterized in which the metering apparatus is disposed with at least a liquid pump connected to a concentrate tubing and a diluting water pump connected to a diluting water tubing. The outlets of the pumps are respectively connected to the outlet of liquid concentrate and diluting water via a check valve tubing. A motor-run lift mechanism is provided at the outlet that ascends or descends according to the button selected for small cup, medium cup or large pot, and stops when the positioning point switch for the selected cup or pot is touched under the control of microprocessor. This design prevents the spurting of dispensed fluid into the cup or pot due to long distance between the outlets of liquid concentrate and diluting water and the rim of cup or pot. The provision of a lift mechanism at the fluid outlet to ensure sanitary and smooth dispensing is a feature of the invention.

In addition, when the concentrate pump stops pumping, there will be some liquid concentrate remaining at the outlet of tubing and forming a semi-sphere shaped drop there. After some time later, say ten minutes or more, the semi-sphere shaped drop of liquid concentrate will start drying out from its appearance due to air flow and temperature. As a result, liquid concentrate will tend to spray toward everywhere when next time the concentrate pump is working again. Therefore, the present invention discloses a pressing mechanism which will compress part of the tubing to squeeze some remaining liquid concentrate out of the outlet, and then let the tubing returning back its original circular shape so as to suck the liquid concentrate located at the outlet back to the interior of tubing. As a result, there will be no more semi-sphere shaped drop remaining at the outlet of tubing. The outlet will become a plane and thus the remaining liquid concentrate inside the tubing will not be easily influenced by the drying effect due to air flow or temperature. Therefore, the liquid concentrate will flow smoothly and vertically toward the cup every time when the concentrate pump operates.

### BRIEF DESCRIPTION OF THE DRAWINGS

FIG. 1 is a diagram showing the layout of an automatic liquid metering apparatus according to the invention.

FIG. 2 is a control panel diagram showing the button selections of an automatic liquid metering apparatus according to the invention.

FIG. 3A is a diagram showing a lift mechanism at the outlets of concentrate and diluting water in an automatic liquid metering apparatus according to the invention.

FIG. 3B is a diagram showing an electromagnetic actuated lift mechanism at the outlets of concentrate and diluting water in an automatic liquid metering apparatus according to the invention.

FIG. 3C is a diagram showing a manually operated lift mechanism at the outlets of concentrate and diluting water in an automatic liquid metering apparatus according to the invention.

FIG. 4 is a diagram showing the movement of concentrate and diluting water in an automatic liquid metering apparatus according to the invention and the seats for small cup, medium cup and large pot.

FIG. 5A is a diagram showing the concentrate bag of the invention full.

FIG. 5B is a diagram showing the trigger of alarm switch when the concentrate bag of the invention becomes empty.

FIG. 6 is a diagram showing the pressing mechanism squeezing the tubing of liquid concentrate according to the automatic liquid metering apparatus of the invention.

### DETAILED DESCRIPTION

The automatic liquid metering apparatus of the invention features the use of microprocessor for precision control of motor pumps and check valves. In the process of drawing and discharging fluid, the running time of motor pump is under microprocessor control to supply precise amounts of liquid concentrate and diluting water for mixing. In the pump for liquid concentrate with less fluidity, its inlet is designed with larger diameter than its outlet such that sufficient amount of liquid is drawn in instantly without creating a vacuum state that causes unstable flow. The control process is linked up in the following fashion: the outlet of liquid concentrate is connected to the inlet of motor pump via a tubing; the outlet of motor pump is connected to the outlet of concentrate jacket assembly of lift mechanism via a check valve tubing; the outlet of diluting water tank is connected to the inlet of motor pump via a pump tubing; the pump outlet tubing is connected to the outlet of diluting water jacket assembly of lift mechanism via a check valve tubing; where accurate amount of drink is supplied based on the choice of small cup, medium cup or large pot provided at the concentrate/diluting water outlet of lift mechanism. For metered supply of liquid drink, place the cup of desired size and then press the button indicating the selected cup on the microprocessor control panel. Next, select the type of liquid desired (D, R or T), and then the amount of liquid concentrate desired. Subsequently, start the lift mechanism where the lifting gear will descend and stop at the point as set by the microprocessor. At this point, the liquid concentrate motor starts to run to supply liquid concentrate as timed by the microprocessor. When the liquid concentrate motor stops, the diluting water motor starts to run to supply water as timed by the microprocessor. After the supply of diluting water stops, the lift mechanism under the control of microprocessor rises to the point where the lifting gear motor stops, and the drink of fixed volume can be taken out. In addition, the lift mechanism disposed at the concentrate/water outlet that ascends or descends the small cup, medium cup or large pot selected to a proper height from the concentrate/water outlet prevents the spurting of dispensed liquid to ensure sanitary and smooth supply of drink. That is, consumers only need to press a few buttons to get the drink of desired concentration and amount.

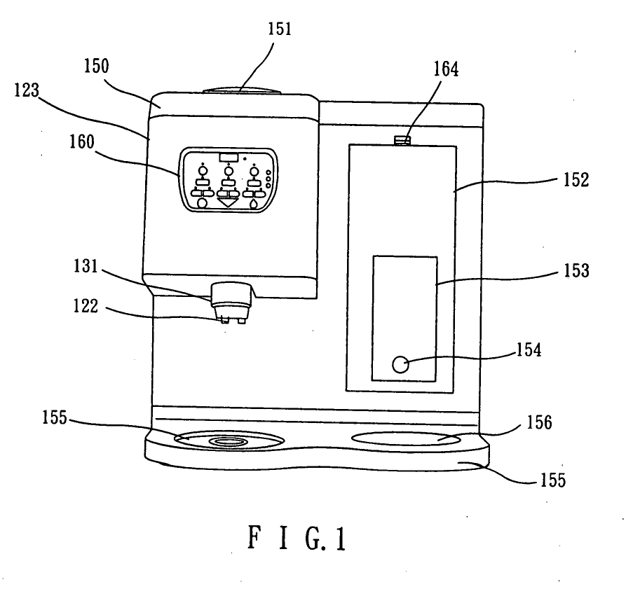

Referring to FIGS. 1˜6, the liquid metering apparatus of the invention comprises at least a power indicator 101, D concentrate motor button 102, R concentrate motor button 103, T concentrate motor button 104, D concentrate timing motor button 105, R concentrate timing motor button 106, T concentrate timing motor button 107, function code and temperature indicator 108, large pot button 109, medium cup button 110, small cup button 111, light button 112, strong button 113, light button 114, strong button 115, light button 116, strong button 117, start button 118, stop button 119, hot water button 120, diluting water tank heater 121, concentrate outlet 122, body 123, motor stand 124, mounting mechanism 125, slide space 126, small cup positioning switch 127, medium cup positioning switch 128, large pot positioning switch 129, liquid jacket assembly stop point 130, liquid jacket assembly 131, heat insulation pad 132, diluting water tubing 133, helical gear shaft 134, lift balancing shaft 135, gear sleeve 136, liquid jacket assembly connecting shaft 137, lifting gear motor 138, lift assembly holder 139, small cup seat 140, medium cup seat 141, large pot seat 142, diluting water tank 143, liquid tubing 144, concentrate check valve 145, diluting water check valve 146, diluting water pump or solenoid valve 147, concentrate pump inlet 148 (large diameter), concentrate pump outlet 149 (small diameter), top cover 150, diluting water tank lid 151, front lid 152, concentrate container 153, adaptor of concentrate bag 154, housing base 155, heating plate 156, concentrate refill inlet cap 157, concentrate refill inlet 158, spring hook 159, microprocessor control panel 160, D concentrate pump 161, R concentrate pump 162, T concentrate pump 163, front lid fastener 164, concentrate level alarm switch 165, electromagnetic actuator 166, electromagnetic actuator shaft 167, fixing bolt 168, fixing seat 169, sliding gap 170, lifting positioning axle 171, lifting swinging arm 172, elastic plate 173, small cup positioning point 174, medium cup positioning point 175, fixing shaft 176 for lifting swinging arm, spring 177, manually actuated arm 178, horn 179, motor 180 of pressing mechanism, axle 181, base 182, right bracket 183 of pressing mechanism, pressing mechanism 184, stopping switch 185 of motor, left bracket 186 of pressing mechanism, semi-sphere shaped drop 187 located at the outlet of silicon tubing, liquid concentrate drops 188 squeezed out from the outlet of silicon tubing, liquid concentrate 189 sucked back to interior of the tubing when the tubing returns back to its original circular shape, and screws 190, 191 and 192. The assembly of aforesaid components provides metered amount of concentrate to meet the user demand.

FIG. 1 is the front view of an automatic liquid metering apparatus according to the invention.

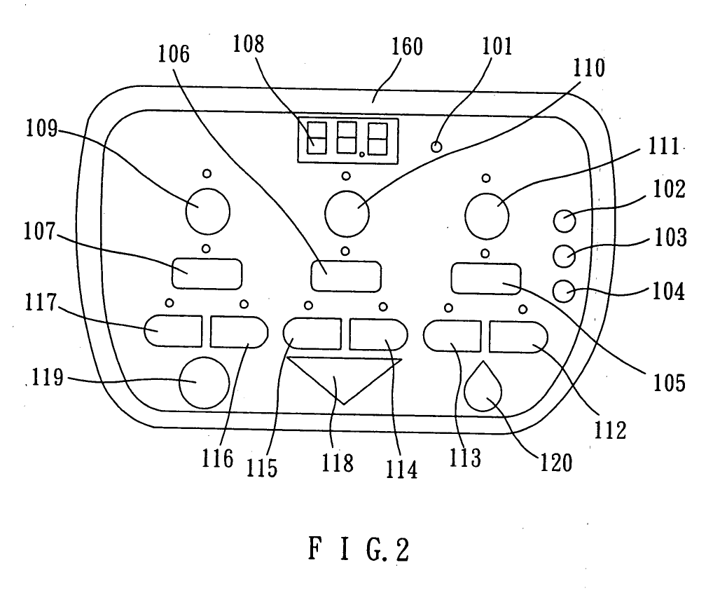

The automatic liquid metering apparatus comprises a body 123 with a top cover 150 thereon. A diluting water tank lid 151 is disposed at the upper left side of the top cover 150, and a microprocessor control panel 160 is disposed beneath the top cover 150. The buttons of the microprocessor control panel 160 are depicted in FIG. 2. Beneath the microprocessor control panel 160 are a concentrate outlet 122 and liquid jacket assembly 131. The housing base 155 is provided with a beverage container stand disposed with a small cup seat 140, medium cup seat 141 and large pot seat 142. A front lid 152 with a fastener 164 is disposed at the right front side of body 123. To replace the bag in the concentrate container 153, press on the front lid fastener 164 to remove the front lid 152 and expose the concentrate container 153. A concentrate bag adaptor 154 is located at the lower part of concentrate container 153 and connected to the concentrate timing motor. A heating plate 156 is seated on the housing base 155 to keep the unused beverage in the large pot warm.

FIG. 2 shows the microprocessor control panel buttons of the liquid metering apparatus.

The buttons of the microprocessor control panel 160 located on the body 123 of the liquid metering apparatus consist of a power indicator 101, D concentrate motor button 102, R concentrate motor button 103, T concentrate motor button 104, D concentrate timing motor button 105, R concentrate timing motor button 106, T concentrate timing motor button 107, function code and temperature indicator 108, large pot button 109, medium cup button 110, small cup button 111, light button 112, strong button 113, light button 114, strong button 115, light button 116, strong button 117, dispense start button 118, stop button 119, and hot water button 120. Its control process is illustrated using the example of making a small cup of drink: to obtain a drink from concentrate, press small cup button 111, then D concentrate timing motor 10 and light button 112. Next press dispense start button 118, upon which, the lifting gear 138 turns to descend the lift mechanism to the small cup positioning switch 127. Then the microprocessor starts to drive the D concentrate timing motor pump 161 to turn and supply liquid concentrate until timeout and starts to drive the diluting water motor pump or solenoid valve 147 until timeout as dictated by the pressing of small cup button 111. Afterwards, the lift mechanism ascends under the reverse rotation of microprocessor-controlled lifting gear motor 138 and stops at the position of large pot positioning switch 129, and the drink may be taken out.

If the start button is pressed by mistake in the process, user can press the stop button 119. There is also a hot water button 120 that instructs the diluting water pump 147 to supply hot water or cold water. The D concentrate motor button 102, R concentrate motor button 103 and T concentrate motor button 104 are pressed to test the discharge and flow rate of concentrate under the working of concentrate motor pump. The D concentrate timing motor button 105, R concentrate timing motor button 106, and T concentrate timing motor button 107 are under microprocessor control to drive and time the running of motor. D, R, T represents the type of concentrate. There may be one type or a plurality of concentrates in the liquid metering apparatus.

The function code and temperature indicator 108 is also microprocessor controlled. When temperature display stops when the timing of function is set. After the timing of function is set, the temperature indicator displays the temperature of hot water in diluting water tank.

In addition, after selecting the large pot button 109, medium cup button 110 or small cup button 111, user may select the D concentrate timing motor button 105, R concentrate timing motor button 106, or T concentrate timing motor button 107 to obtain the desired drink.

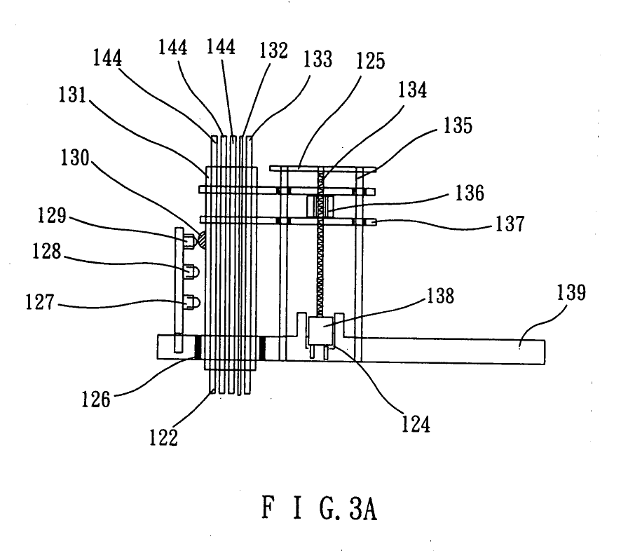

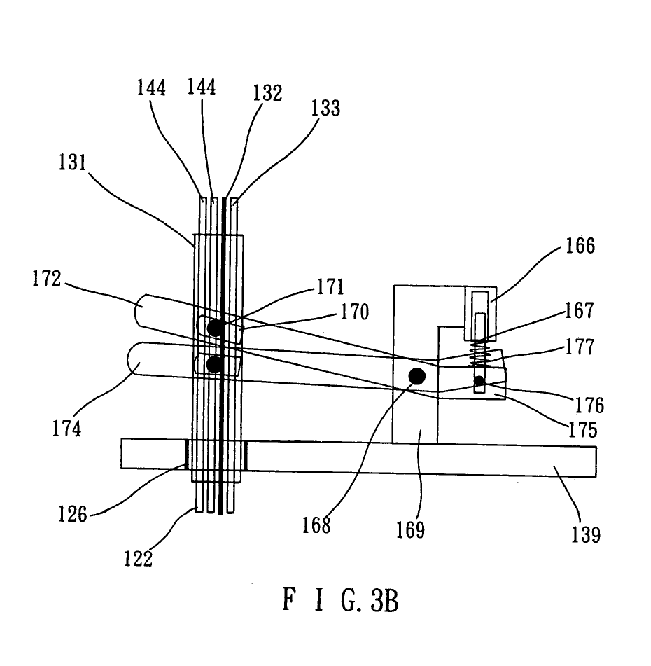

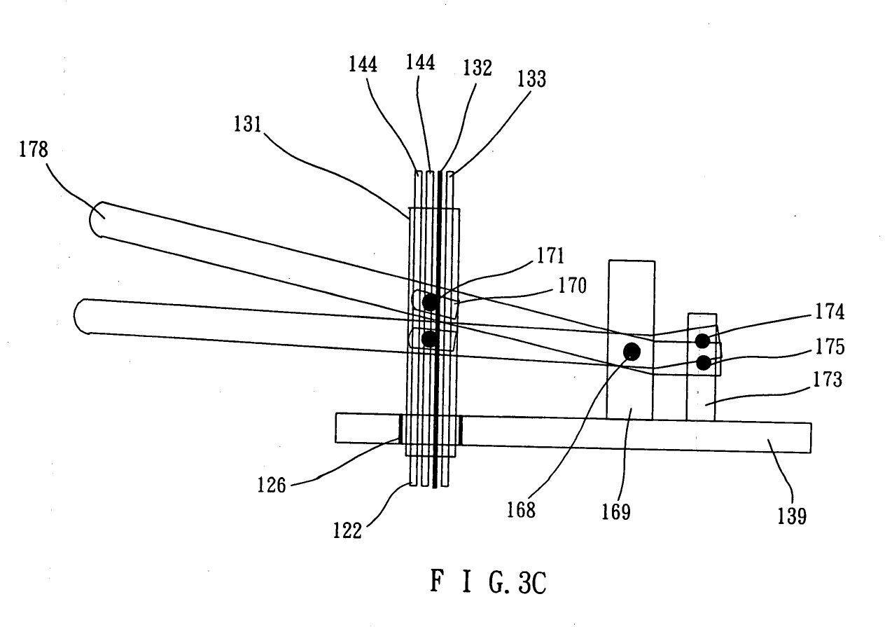

FIG. 3A is a diagram showing a lift mechanism at the outlets of liquid concentrate and diluting water in an automatic liquid metering apparatus according to the invention.

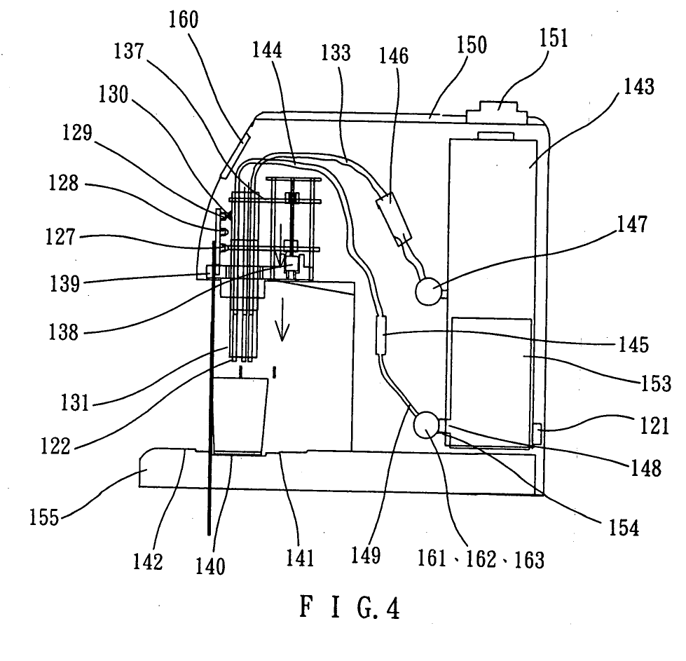

The lift mechanism is disposed with a small cup positioning switch 127, a medium cup positioning switch 128, and a large pot positioning switch 129 which corresponds respectively to the height of small cup, medium cup and large pot. The control point is set at the liquid jacket assembly 131 stop point 130 where motor running stops when it moves to the stop point as dictated by the choice of small cup, medium cup and large pot buttons on the microprocessor control panel. The liquid jacket assembly 131 is disposed with three concentrate outlets, a diluting water outlet and a heat insulation pad 132. The heat insulation pad 132 is installed to block heat transfer from diluting water which is hot water to the three concentrate sets so as to retain their original flavor. The liquid jacket assembly 131 is secured to the liquid jacket assembly connecting shaft 137. The connecting shaft 137 is the assembly of a lift balancing shaft 135 and mounting mechanism 125 and secured to the lift assembly holder 139. On the rack of liquid jacket assembly connecting shaft 137, there is a gear sleeve 136 with helical gear shaft 134 disposed in the middle. The helical gear shaft 134 is linked to and rotates with the axis of lifting gear motor 138 seated on motor stand 124 of lift assembly holder 139. The lift assembly holder 139 is provided with a slide space 126 that makes the vertical movement of the axis of lifting gear motor 138 coupled with the liquid jacket assembly 131 easier. The liquid jacket assembly connecting shaft 137 is also provided with a slide space 126 that makes the vertical movement of lifting gear motor 138 coupled with the liquid jacket assembly 131 easier. In the aforesaid assembly structure, the liquid jacket assembly 131 will not be displaced by weight with the use of helical gears. Thus this lift mechanism has a stable design. The movement of the lift mechanism is also microprocessor controlled as shown in FIG. 4. Furthermore, the lifting distance of the lift mechanism is adjustable according to user's requirement.

FIG. 3B is a diagram showing an electromagnetic actuated lift mechanism at the outlets of concentrate and diluting water in an automatic liquid metering apparatus according to the invention.

The lift mechanism is actuated by the electromagnetic actuator 166. The electromagnetic actuator 166 actuates the electromagnetic actuator shaft 167 to move in and out so as to control the liquid jacket assembly 131 to move between some predetermined lifting positioning points. The electromagnetic actuator 166 is fixed on the fixing seat 169 for lifting swinging arm. The outer surface of the electromagnetic actuator shaft 167 is furnished with the spring 177, and the electromagnetic actuator shaft 167 is fixed to one end of the lifting swinging arm 172 by means of the fixing shaft 176 in such a manner that the lifting swinging arm 172 is swingable about the fixing bolt 168 when the electromagnetic actuator 166 actuates the electromagnetic actuator shaft 167 to move in and out. The lifting swinging arm 172 is fixed to the fixing bolt 168 of the fixing seat 169 for lifting swinging arm. The liquid jacket assembly 131 is furnished with the lifting positioning axle 171. The sliding gap 170 is formed between the lifting swinging arm 172 and the lifting positioning axle 171 adjacent to the liquid jacket assembly 131 because the displacement will occur when the liquid jacket assembly 131 is lifting up and down. The fixing seat 169 of lifting swinging arm 172 is fixed to the lift assembly holder 139 of the liquid jacket assembly 131. By means of the aforesaid mechanism, when someone wants to get concentrate beverage such as concentrated coffee from the automatic liquid metering apparatus of the present invention, the user can push the button to start the microprocessor program controlled circuit to control the liquid jacket assembly 131 to lift to a selected positioning point, such like the small cup positioning point 174 or the medium cup positioning point 175. he electromagnetic actuator 166 is powered for actuating the lifting swinging arm 172 to move together with the outlet jacket assembly containing the concentrate liquid tubing and dilute water tubing to the selected positioning point. When the feeding of the concentrate liquid and the dilute water is completed, the lift mechanism is moved back to the initial position by cutting off the power of the electromagnetic actuator which is controlled by the microprocessor program controlled circuit. As a result, the precise supply of the concentrate liquid and dilute water can be achieved, and the requirement of users is fulfilled.

FIG. 3C is a diagram showing a manually operated lift mechanism at the outlets of concentrate and diluting water in an automatic liquid metering apparatus according to the invention.

The lift mechanism is actuated by manually swinging the manually actuated arm 178 for lifting the liquid jacket assembly 131 to the selected positioning points. The manually actuated arm 178 is fixed to the mid point of lifting swinging arm of the fixing seat for lifting swinging arm 172. The liquid jacket assembly 131 is furnished with the lifting positioning axle 170 for movably connecting to the manually actuated arm 178. The sliding gap 170 is formed between the manually actuated arm 178 and the lifting positioning axle 171 adjacent to the liquid jacket assembly 131 because the displacement will occur when the liquid jacket assembly 131 is lifting up and down. The positioning of the manually actuated arm 178 is achieved by forming a small cup positioning point 174 and a medium cup positioning point 175 on the elastic plate 173. The fixing seat 169 for lifting swinging arm 172 and the elastic plate 173 are fixed to the lift assembly holder 139.

By means of the aforesaid mechanism, when someone wants to get concentrate beverage (such as concentrated coffee) from the automatic liquid metering apparatus of the present invention, the user can push the button to start the microprocessor program controlled circuit, and, in the mean time, the user can swing the manually actuated arm 178 to move the liquid jacket assembly 131 together with the concentrate liquid tubing and dilute water tubing to a selected positioning point such as small cup or medium cup. Then, the microprocessor program controlled circuit will control to supply predetermined quantity of concentrate liquid and the dilute water according to the positioning point of the liquid jacket assembly 131. As a result, the precise supply of the concentrate liquid and dilute water can be achieved, and the requirement of users is fulfilled.

FIG. 4 is a sectional view of the microprocessor control process of the liquid metering apparatus according to the invention.

As shown, the body 123 is configured with a microprocessor control panel 160, a top cover 150, and a diluting water tank lid 151 on its exterior. Inside the body 123, there are arranged with a diluting water tank 143, a concentrate container 153, and a lift mechanism to provide an integral, microprocessor-controlled process, and a small cup seat 140, a medium cup seat 141, and large cup seat 142. To make a drink from the concentrate, connect the adaptor 154 at the lower part of concentrate container 153 to the liquid tubing 144, which is connected to the inlet of D, R, T concentrate pump 161, 162, 163. If a small cup of drink is desired, put the small cup over its seat 140 on the housing base 155, press the small cup button on the microprocessor control panel 160, then select the type of concentrate desired by pressing any of the concentrate motor buttons and indicate the preference of light or strong drink by pressing the light or strong button. Next, press the start button. At this time, the lifting gear motor 138 of the lift mechanism starts to run under microprocessor control, upon which, the liquid jacket assembly connecting shaft 137 and the liquid jacket assembly 131 begin the move down until reaching the liquid jacket assembly stop point 130 and contacting the small cup positioning switch 127 when the lifting gear motor 138 stops running. Then the microprocessor will drive the D, R, or T concentrate pump 161, 162, 163 as dictated by the type of concentrate selected. The concentrate pump will send the desired concentrate to the concentrate outlet 122 via the liquid tubing 144 and concentrate check valve 145 and discharge the metered amount set before the pump stops running. The microprocessor will also drive the diluting water pump or solenoid valve 147 to discharge metered amount of hot water into the cup via the diluting water check valve 146 and diluting water tubing 133. The microprocessor then drives the lifting gear motor 138 of lift mechanism to rotate reversely and the lift mechanism will ascend until the lifting gear motor 138 contacts with the large pot positioning switch 129. As this time, the drink made from concentrate may be removed from the apparatus. Because of the lift mechanism at the liquid outlet, liquid discharged into the cup will not spurt out. Also, in light of the poor fluidity of concentrate, the concentrate pump is designed with a larger diameter inlet 148 and a smaller diameter outlet 149 so sufficient amount of concentrate is drawn in and a metered amount of concentrate is dispensed. Also a recess may be provided on the housing base for the seating of small cup 140, medium cup 141 and large pot 142 respectively to make it easier for user to know where to place the cup.

With the arrangement of a diluting water tank heater 121 in the diluting water tank 143, the diluting water may be cold water or hot water as set by the microprocessor program. The temperature of diluting water may be detected and displayed by a temperature sensor.

If the microprocessor did not receive the instruction from medium cup button 110, the liquid jacket assembly stop point 130 in the lift mechanism will not act when it is in contact with (passes) the medium cup positioning switch 128.

The lifting gear motor 138, liquid jacket assembly connecting shaft 137, small cup positioning switch 127, medium cup positioning switch 128, and large pot positioning switch 129 are all secured to the lift assembly holder 139. The lift assembly holder 139 is secured to the body 123 on a platform beneath the microprocessor control panel 160.

Moreover, the present invention can also apply the following lifting method as an option. That is, the liquid jacket assembly connecting shaft 137 and the liquid jacket assembly 131 are firstly moved downward to the stop point 130 so as to contact the small cup positioning switch 127. The lifting gear motor 138 of the lift mechanism can be set up by means of time delay to move a bit more lower after the small cup positioning switch 127 is pushed, such that the concentrate outlet 122 will be located inside the cup before the lifting gear motor 138 is actually stopped. When the feeding of concentrate liquid (e.g., concentrate beverage) is complete, the liquid jacket assembly 131 will then move up to the top end of the cup for feeding dilute water. As a result, the dilute water supplied by the diluting water motor pump will not spill nor contact the liquid jacket assembly 131 and the concentrate outlet 122, which is also a characteristic of the present invention.

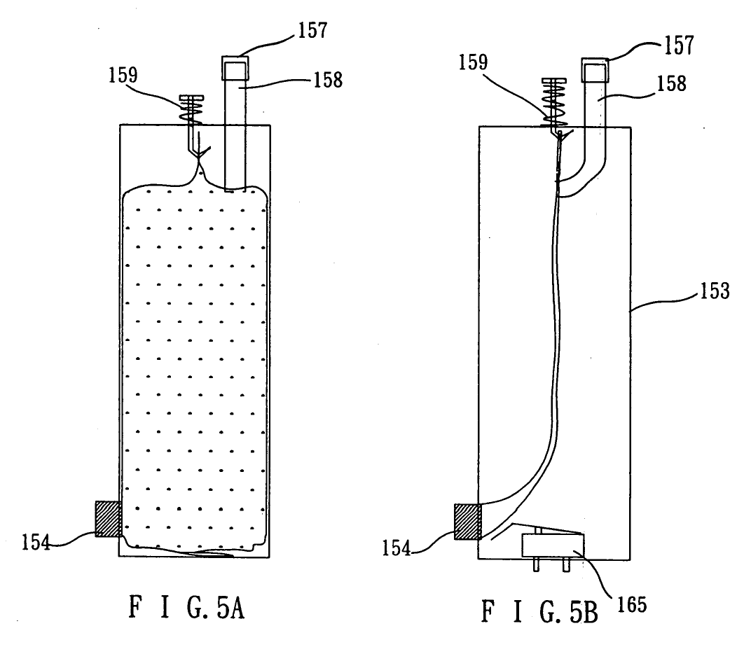

FIG. 5A and FIG. 5B show the manner of refilling the concentrate bag of a liquid metering apparatus according to the invention and the trigger of alarm when the bag becomes empty.

As shown, the concentrate bag is placed in a concentrate container 153 disposed with a concentrate level alarm switch 165 at its bottom. The concentrate bag is made of soft material, such as aluminum foil or non-toxic plastic or rubber. An adaptor 154 is provided at the lower part of concentrate bag and an eyelet is provided in the upper part of the bag to provide an attachment point for the spring hook 159. A concentrate refill inlet 158 with a cap 157 is disposed at the top of concentrate container. When the concentrate bag is full (as shown in FIG. 5A) and fills the concentrate container 153, the spring hook 159 is pulled down by the weight of concentrate and the bag presses down on the concentrate level alarm switch 165. As the concentrate is being depleted, the spring hook 159 lifts the concentrate bag away from the concentrate level alarm switch 165 (as shown in FIG. 5B), which will send out an alarm. Apparatus operator only needs to removes the cap 157 over the concentrate inlet 158 to refill the emptying concentrate bag.

To replace the empty concentrate bag instead of refill, operator can press the front lid fastener 164 of body 123 to access the concentrate container 153 and remove the empty bag by detaching it from the adaptor 154.

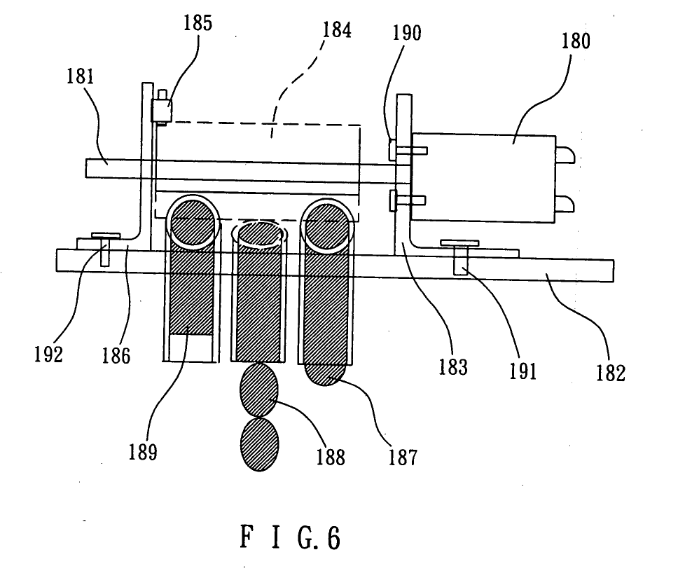

FIG. 6 is a diagram showing the pressing mechanism squeezing the tubing of liquid concentrate according to the automatic liquid metering apparatus of the invention.

The automatic liquid metering apparatus of the present invention is further furnished with a motor 180 of pressing mechanism which is fixed to the right bracket 183 of pressing mechanism by the screw 190. The right bracket 183 is fixed to the base 182 by the screw 191. The pressing mechanism 183 is fixed to the axle 181. One end of the axle 181 is connected to the motor 180, while the other end is pivoted on the left bracket 186 which is fixed to the base 182 by the screw 192. The stopping switch 185 of motor is furnished on the left bracket 186. The silicon tubing of liquid concentrate is located between the pressing mechanism 184 and the base 182. The operating process of the pressing mechanism 184 is schematically illustrated by means of numerals 187, 188 and 189 shown in FIG. 6. For example, when the concentrate pump stops pumping, there will be some liquid concentrate remaining at the outlet of tubing and forming a semi-sphere shaped drop 187 there. After some time later, say ten minutes or more, the semi-sphere shaped drop 187 of liquid concentrate will start drying out from its appearance due to air flow and temperature. As a result, liquid concentrate will tend to spray toward everywhere when next time the concentrate pump is working again. Therefore, the present invention discloses the motor 180 of pressing mechanism that will automatically operate to rotate the pressing mechanism 184 after the concentrate pump stops pumping. When the motor 180 rotates the pressing mechanism 184, the pressing mechanism 184 compresses part of the tubing to squeeze some liquid concentrate out of the outlet so as to form the drops 188. And, after a full turn of rotation, the pressing mechanism 184 contacts the stopping switch 185 and causes the motor 180 to stop rotation, and then the tubing returns back to its original circular shape due to its own resilience so as to suck the liquid concentrate 189 located at the outlet back to the interior of tubing. As a result, there will be no more semi-sphere shaped drop remaining at the outlet of tubing. The outlet will become a plane and thus the remaining liquid concentrate 189 inside the tubing will not be easily influenced by the drying effect due to air flow or temperature. Therefore, the liquid concentrate will flow smoothly and vertically toward the cup every time when the concentrate pump operates again.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. An automatic liquid metering apparatus, comprising at least:
a concentrate container for storing liquid concentrate placed in a bag;
a motor pump connected to the concentrate container;
a check valve connected to the motor pump;
a solenoid valve for controlling the supply of diluting water;
a microprocessor control circuit used to control the turning of motor pump so as to draw in the liquid concentrate and direct it into a vessel via the check valve, and used to control the turning of motor pump to discharge diluting water into a vessel via the check valve or open the solenoid valve to allow the diluting water to flow into a vessel; and
a front lid assembly, including a fastener;
wherein the flow rates of liquid concentrate and diluting water are set based on needs by adjusting the microprocessor control circuit, and when the bag in the concentrate container needs to be replaced, the concentrate container may be exposed and removed by pressing down the fastener of the front lid assembly and pushing the front lid assembly forward; the concentrate bag may be replaced by detaching it from the adaptor of concentrate container.

2. An automatic liquid metering apparatus, comprising at least a concentrate container, a concentrate bag, a hook, and a concentrate level alarm switch assembly, characterized in which:
the concentrate bag contained in the concentrate container is a soft aluminum foil or plastic bag, which expands when it is filled with concentrate and shrinks when the concentrate is being depleted;
an eyelet is provided at the upper part of the bag for the bag to be hooked inside the concentrate container; a concentrate refill inlet and an inlet cap are also provided at the top of the bag, and a concentrate outlet adaptor is disposed at the bottom of the bag;
the concentrate level alarm switch is arranged at the bottom of concentrate container, which is pressed down by the bag when the bag is filled with concentrate; when the concentrate is depleted, the bag is lifted by the hook in flat shape, upon which the alarm switch will send out alarm as it is separated from the concentrate bag.

3. An automatic liquid metering apparatus, comprising at least a motor, a helical gear, a helical shaft, a mounting stand, a concentrate/diluting water outlet, a positioning switch, a microprocessor control circuit, and a lift mechanism coupled to the base, characterized in which:
the microprocessor control circuit can set a positioning point by pressing at least a button; said positioning point is for adjusting the vertical position of the concentrate/diluting water outlet to correspond to the amount of concentrate and diluting water to be dispensed for a small cup, a medium cup or a large pot; the vertical position of said outlet is adjusted corresponding to the location of the positioning point;
to dispense concentrate and diluting water, the motor will turn the helical shaft to drive the movement of helical gear, which is linked to the concentrate/diluting water outlet through the mounting stand to move the outlet to the positioning point set, upon which, the positioning switch is touched and the turning of motor stops; after the mix of concentrate/diluting water is dispensed, the lift mechanism will return to the highest default positioning point under the control of microprocessor control circuit.

4. The automatic liquid metering apparatus according to claim 1, characterized in which:
the inlet of said motor pump is bigger than its outlet;
the supply of concentrate is connected to a check valve through a tubing;
the microprocessor control circuit controls the rotation of motor pump to discharge diluting water through the tubing and check valve or discharge diluting water into the tubing by opening the solenoid valve;
the outlets of concentrate tubing and diluting water tubing are assembled into an outlet jacket; to dispense the concentrate, a button connected to the microprocessor control circuit is pressed to determine a positioning point and thereby the amount of concentrate to be dispensed; at this time, the motor of a lift mechanism turns a helical shaft to drive the movement of a helical gear, which is linked to the outlet jacket through a mounting stand to move the outlet jacket to the positioning point set, upon which, a positioning switch is touched and the turning of motor stops; subsequently, the motor pump turns and discharge concentrate and diluting water into the vessel, and the lift mechanism returns to a default positioning point.

5. The automatic liquid metering apparatus according to claim 3, characterized in which:
the inlet of said motor pump is bigger than its outlet;
the supply of concentrate is connected to a check valve through a tubing;
the microprocessor control circuit controls the rotation of motor pump to discharge diluting water through the tubing and check valve or discharge diluting water into the tubing by opening the solenoid valve;
the outlets of concentrate tubing and diluting water tubing are assembled into an outlet jacket; to dispense the concentrate, a button connected to the microprocessor control circuit is pressed to determine a positioning point and thereby the amount of concentrate to be dispensed; at this time, the motor of a lift mechanism turns a helical shaft to drive the movement of a helical gear, which is linked to the outlet jacket through a mounting stand to move the outlet jacket to the positioning point set, upon which, a positioning switch is touched and the turning of motor stops; subsequently, the motor pump turns and discharge concentrate and diluting water into the vessel, and the lift mechanism returns to a default positioning point.

6. The automatic liquid metering apparatus according to claim 1, characterized in which the inlet diameter of the motor pump of said metering apparatus is bigger than its outlet.

7. The automatic liquid metering apparatus according to claim 1, characterized in which the microprocessor is disposed with a button panel having thereon: at least a button to drive the concentrate motor pump directly, at least a button to set time, a temperature indicator and function code indicator, at least a concentrate type button, a button to drive water supply directly, a stop button, a button for strong drink, a button for light drink, and a concentrate level alarm to support the functions of drink dispenser.

8. The automatic liquid metering apparatus according to claim 4, wherein the motor pump and the microprocessor control circuit for lift mechanism are disposed with a plurality of photoelectric switches for the adjustment of positioning point and time set.

9. The automatic liquid metering apparatus according to claim 3, wherein the positioning point of lift mechanism set for the height of liquid dispensing is adjustable based on needs.

10. The automatic liquid metering apparatus according to claim 2, wherein when the concentrate in the bag is depleted, the bag becomes flat and the concentrate level alarm switch will be separated from the bag and send out an alarm to remind the refill of concentrate or replacement of concentrate bag.

11. The automatic liquid metering apparatus according to claim 1, wherein after the concentrate bag is depleted, its replacement may be performed by pressing the front lid fastener of body and moving the front lid assembly forward to expose the concentrate container and remove the empty bag by detaching it from the adaptor.

12. An automatic liquid metering apparatus, comprising at least an electromagnetic actuator, an electromagnetic actuator shaft, a spring, a fixing bolt, a sliding gap, a lifting positioning axle, a lifting swinging arm, an elastic plate, a fixing seat for lifting swinging arm, a fixing shaft, an outlet for concentrate liquid and dilute water, a microprocessor program controlled circuit, a liquid jacket assembly, and a lift mechanism of the liquid jacket assembly, wherein the microprocessor program controlled circuit controls the liquid jacket assembly to be lifted by the lift mechanism to a selected positioning point such as a small cup or a medium cup, then the electromagnetic actuator actuates the lifting swinging arm to move together with the outlet for concentrate liquid and dilute water to said positioning point and starts supplying concentrate liquid and dilute water, and then, after the supply of concentrate liquid and dilute water is completed, power of the electromagnetic actuator is switched off by the microprocessor program controlled circuit, and the lift mechanism lifts the liquid jacket assembly back to an initial position.

13. The automatic liquid metering apparatus according to claim 12, wherein the lift mechanism can be operated by manually swinging a manually actuated arm for moving the outlet for concentrate liquid and dilute water to said positioning point.

14. The automatic liquid metering apparatus according to claim 12, wherein the lifting distance of the lift mechanism is adjustable according to user's requirement.

16. An automatic liquid metering apparatus, comprising a motor of pressing mechanism, an axle, a base, a right bracket of pressing mechanism, a pressing mechanism, a stopping switch of motor and a left bracket of pressing mechanism; wherein, when a concentrate pump stops pumping, the pressing mechanism squeeze out some liquid concentrate from a tubing so as to prevent the liquid concentrate from remaining at an outlet of the tubing.

17. The automatic liquid metering apparatus according to claim 16, wherein, when the concentrate pump stops pumping, the motor drives the pressing mechanism to compress the tubing in order to squeeze out some liquid concentrate inside the tubing; and then, when the motor stops driving the pressing mechanism, the tubing returns back to its original shape and thus sucks some liquid concentrate back into interior of the tubing so as to avoid the liquid concentrate remaining at outlet of the tubing.
